(19) United States
(12) Patent Application Publication
(10) Pub. No.: US 2010/0153333 A1
(43) Pub. Date: Jun. 17, 2010

(54) Method of and System for Managing Drill-Through Source Metadata

(76) Inventors: Glenn D. Rasmussen, Nepean (CA); David Dewar, Manotick (CA); Katherine Wallace, Ottawa (CA)

Correspondence Address: Walder Intellectual Property Law PC, 17330 Preston Road, Suite 100B, Dallas, TX, 75252, US

(21) Appl. No.: 12/336,929

(22) Filed: Dec. 17, 2008

(51) Int. Cl. G06F 7/06; G06F 17/30

(52) U.S. Cl. 707/603; 707/E17.014; 707/758

(57) ABSTRACT

A source drill-through metadata manager comprises a source drill-through metadata handler and a source specification processor. The source drill-through metadata handler defines and manages source drill-through metadata in a metadata model for query items that are drill-through source items. The source specification processor automatically analyzes query items used in a report definition to locate any query item that is related to a query item defined as a drill-through source item based on the source drill-through metadata so as to identify one or more relevant drill-through source query items for one or more query items located during the analyzing, and automatically adding one or more relevant data items to a source report definition.

### FIELD OF THE INVENTION

The present invention relates to a method of and system for managing drill-through source metadata.

### BACKGROUND OF THE INVENTION

There exist reporting tools that generate reports of filtered data from underlying data sources. These tools often allow users to navigate from a source report to a target report, using values selected in the source report to filter data in the target report. This type of navigation is commonly known as “drill-through”. By drilling through, users can explore or browse items in the reports. For example, when two reports are in a master/detail relationship, by clicking an item in the master report, the user can reach the details of the clicked item in the detail report. The component from which drill-through is initiated is referred as the drill-through source and the component in which drill-through is terminated is referred as the drill-through target. This relationship between a drill-through source and target is known as a drill-through path. A component may act as both drill-through source and target, such as in a parts explosion, in one drill through path. A component may be a drill-through source in one drill-through path, and a target in another drill-through path. A component may participate in an arbitrary number of drill-through paths.

In order to provide drill-through capabilities in their application, a report designer or author needs to predefine the drill-through paths between the reports that form the application. Generally speaking, a drill-through path identifies a single target object (such as a report) and may also provide parameter mappings which allow the target to filter its data based on data values provided by the source. It may also provide a scope qualifier that controls when the drill-through path may be used. A drill-through path need not specify a source, since it is implicit, i.e., for authored drill through, the source is the report that contains the drill-through path, and for modeled drill through, the source is any object based on the package that contains the drill-through path.

In many cases, a user wants to navigate to a report containing detailed information about the particular entity selected in the source report. In these cases, it is necessary to provide one or more data items that can uniquely identify the entity in the target report. For example, drill-through using a product code (i.e. UPC) is more appropriate than using a label, such as “Hand Soap”, as the label may not identify a single product. Reports created by report authors may not include these necessary identifiers in many cases, as they are not meaningful values to report consumers who are typically unfamiliar with identifying codes, preferring instead to use captions or labels.

In existing systems, report authors need to understand which query items are identifiers that are necessary to support drill-through, and need to include these items in their reports manually.

It is therefore desirable to provide a mechanism to automatically provide necessary identifiers in a source report to support drill-through operations.

### SUMMARY OF THE INVENTION

It is an object of the invention to provide an improved drill-through source management mechanism that obviates or mitigates at least one of the disadvantages of existing systems.

The invention stores metadata related to drill-through in model items defined in the domain of the drill-through source. Additional data items can be added to a report definition automatically based on the provided drill-through metadata. Once included in the report definition, these data items provide identifying data values for entities in the source report. These data values may be passed to drill-through targets to provide effective filtering of data.

In accordance with an aspect of the present invention, there is provided a source drill-through metadata manager comprising a source drill-through metadata handler and a source specification processor. The source drill-through metadata handler is provided for defining and managing source drill-through metadata in a metadata model for one or more query items that are drill-through source items. The source specification processor is provided for automatically analyzing data items used in a report definition to locate any data item that uses a query item that is related to a query item defined as a drill-through source item based on the source drill-through metadata so as to identify one or more relevant drill-through source data items for one or more query items located during the analyzing, and automatically adding the one or more relevant drill-through source data items to a source report definition.

In accordance with another aspect of the invention, there is provided a method of managing drill-through source metadata. The method comprises the steps of defining, in a metadata model, source drill-through metadata for one or more query items that are drill-through source items; analyzing data items used in a report definition to locate any query item that is related to a query item defined as a drill-through source item based on the source drill-through metadata; identifying one or more relevant drill-through source query items for one or more query items located during the analyzing, and automatically adding the one or more relevant data items based on the drill-through source query items to a source report definition.

In accordance with another aspect of the invention, there is provided a drill-through metadata management system comprising a source drill-through metadata manager and a target drill-through metadata manager. The source drill-through metadata manager has a source drill-through metadata handler and a source specification processor. The source drill-through metadata handler is provided for defining and managing source drill-through metadata in a metadata model for one or more model items that are drill-through source items. The source specification processor is provided for automatically analyzing query items used in a report definition to locate any query item that is related to a model item defined as a drill-through source item based on the source drill-through metadata so as to identify one or more relevant drill-through source data items for one or more query items located during the analyzing, and automatically adding the one or more relevant drill-through source data items to a source report definition. The target drill-through metadata manager has a target drill-through metadata handler and a target specification processor. The target drill-through metadata handler is provided for defining and managing target drill-through metadata in a metadata model for one or more model constructs that are drill-through target constructs. The target specification processor is provided for processing a target report definition using the target drill-through metadata to locate a data item that refers to a drill-through target construct or part of a drill-through target construct, and automatically adding one or more target filters associated with the target drill-through construct to a target report.

In accordance with another aspect of the invention, there is provided a computer readable medium storing instructions or statements for use in the execution in a computer of a method of managing drill-through source metadata. The method comprises the steps of defining, in a metadata model, source drill-through metadata for one or more query items that are drill-through source items; analyzing query items used in a report definition to locate any query item that is related to a query item defined as a drill-through source item based on the source drill-through metadata; identifying one or more relevant drill-through source query items for one or more query items located during the analyzing, and automatically adding the one or more relevant data items to a source report definition.

This summary of the invention does not necessarily describe all features of the invention.

### BRIEF DESCRIPTION OF THE DRAWINGS

These and other features of the invention will become more apparent from the following description in which reference is made to the appended drawings wherein:

FIG. 1 is a block diagram showing a drill-through metadata management system in accordance with an embodiment of the present invention;

FIG. 2 is a block diagram showing an embodiment of the source drill-through metadata manager;

FIG. 3 is a diagram showing an example of processes of creation of a report definition and generation of a report;

FIG. 4 is a diagram showing an example of the operation of the drill-through metadata management system;

FIG. 5 is a block diagram showing another embodiment of the source drill-through metadata manager;

FIG. 6 is a flowchart showing an embodiment of a method of managing drill-through sources;

FIG. 7 is a block diagram showing another embodiment of a drill-through metadata management system;

FIG. 8 is a block diagram showing an embodiment of a target metadata manager;

FIG. 9 is a block diagram showing an embodiment of a drill-through filter construction manager;

FIG. 9A is a block diagram showing an embodiment of a target specification processor;

FIG. 10 is a diagram showing an example of a metadata model;

FIG. 11 is a diagram showing an example of drill-through filters; and

FIG. 12 is a flowchart showing an embodiment of a method of managing drill-through targets.

### DETAILED DESCRIPTION OF PREFERRED EMBODIMENTS

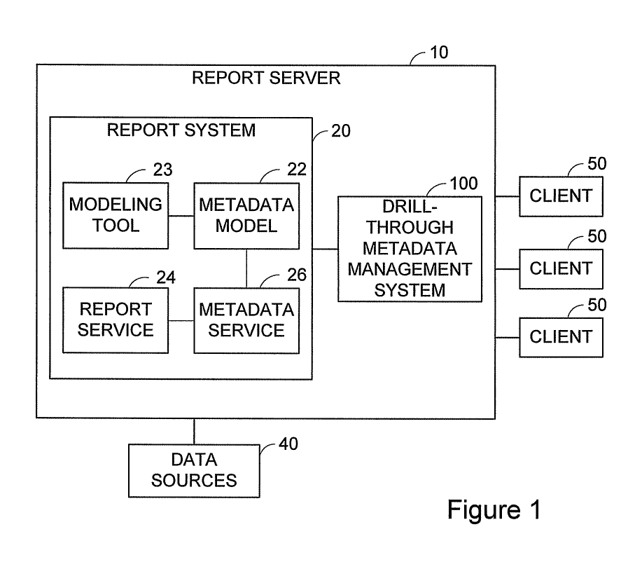

FIG. 1 shows a drill-through metadata management system 100 in accordance with an embodiment of the present invention. The drill-through metadata management system 100 can be suitably used with a report system 20 that generates reports of data in one or more underlying data sources 40.

The report system 20 has a metadata model 22, a modeling tool 23, a report service 24 having a query engine, and a metadata service 26. The metadata model 22 stores metadata describing the structure and business rules of the underlying data sources 40. The modeling tool 23 allows a modeler to manage the metadata model 22. The report service 24 accesses the metadata model 22 using the metadata service 26 to process report definitions containing queries to access data in the underlying data sources 40. The metadata service 26 provides services related to the metadata in the metadata model 22.

The report system 20 and the drill-through metadata management system 100 are typically provided in a report server 10 and users access them through client computer systems 50. In this embodiment, the drill-through metadata management system 100 is provided as a separate component from the report system 20. In a different embodiment, the drill-through metadata management system 100 may be incorporated in a report tool.

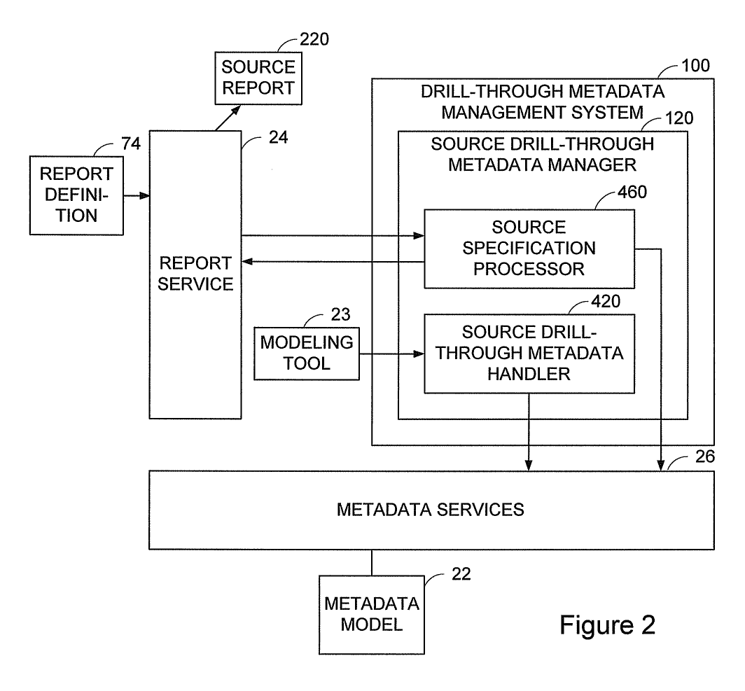

As shown in FIG. 2, the drill-through metadata management system 100 has a source drill-through metadata manager 120. The source drill-through metadata manager 120 manages source drill-through metadata for query items and the addition of data items to reports at runtime based on the source drill-through metadata to provide the report consumer with additional drill-through opportunities by making more identifying items available. A query item is an item defined in a metadata model that can be used to form a query. Values for query items are defined by expressions that refer to data source constructs such as table columns, dimensions, hierarchies, levels and attributes. A simple query item references a single data source construct. A data item is an item in a report query. Values for a data item are defined by an expression that may refer to query items defined in the metadata model and other data items defined in the report. An expression may also refer to other constructs defined by the reporting system and constants. A simple data item references a single query item. The source drill-through metadata manager 120 works with the report service 24, modeling tool 23 and the metadata service 26 of the report system 20 (FIG. 1).

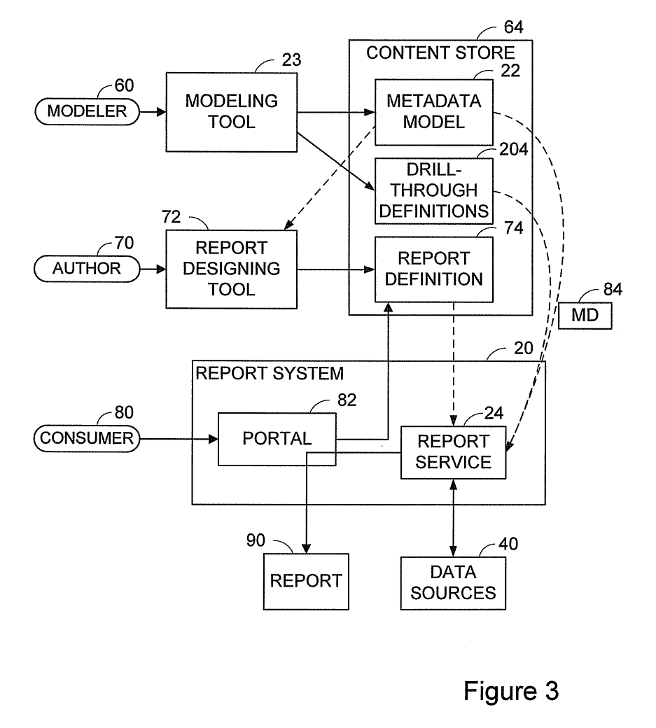

Prior to describing the source drill-through metadata manager 120 in detail, referring to FIG. 3, an example of general processes of metadata model creation, report designing and report execution is described. For the data sources 40, a modeler 60 creates a metadata model 22 using a modeling tool 23, and publishes the metadata model 22 into a content store 64. The modeler 60 also authors drill-through definitions, or drill-through paths 204, and publishes them into the content store 64. When a report author 70 designs a report definition 74 using a report designing tool 72, the report designing tool 72 reads and uses relevant metadata from the metadata model 22 in the content store 64. The designed report definition 74 is a specification that contains queries for obtaining desired data from the underlying data source 40 and layout information for the data in an output report. The designed report definition 74 is normally stored in the content store 64, but it may be stored in a separate store. When a consumer 80 wants to generate a report 90 based on the report definition 74, the consumer 80 runs or executes the report definition 74 through a portal 82 of the report system 20. This causes the report service 24 of the report system 20 to read the report definition 74, and relevant metadata 84 from the metadata model 22 stored in the content store 64. The report service 24 processes the queries in the report definition 74 and accesses the data sources 40 to obtain the desired data. Thus, the report system 20 generates the report 90 with the data through the portal 82.

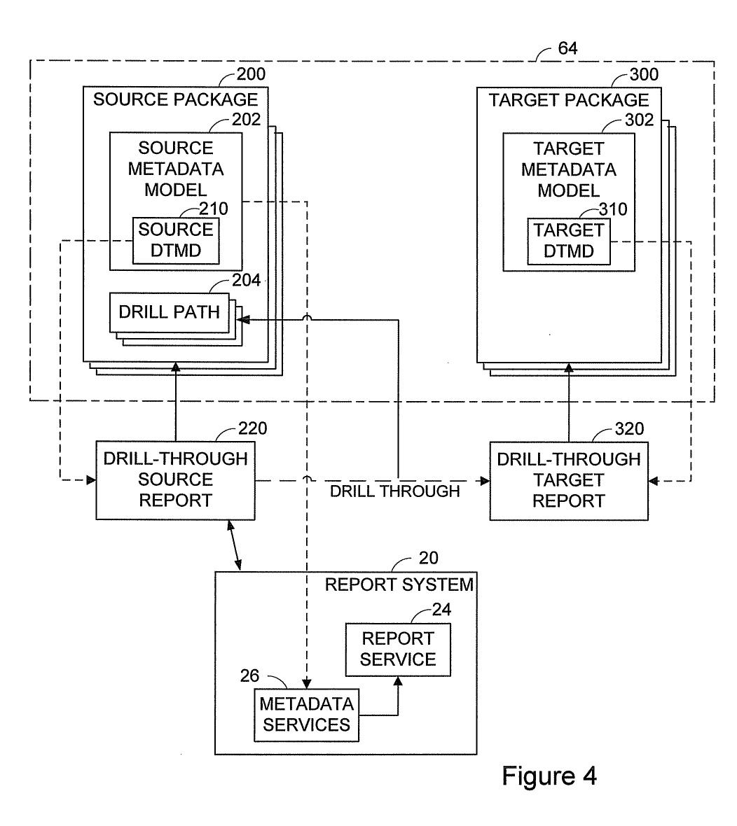

FIG. 4 schematically illustrates an example of the operation of the drill-through metadata management system 100. FIG. 4 is described using the example shown in FIG. 3. When the modeler 60 creates the metadata model 22 (FIG. 3), the modeler 60 also creates source packages 200 in the content store 64. For example, a source package is created for a selected application domain, e.g., “sales”, “inventory”, and so on. A package may act as both a source package 200 and a target package 300. A package 200, 300 contains a metadata model 202, 302 that provides metadata representing the relevant application domain. The metadata model 202, 303 may also contain additional metadata 210, 310 that describes how query items can be used when they are used in the context of a drill-through operation. A source package 200 may contain drill-through definitions, or drill paths 204. Drill paths 204 use the query items defined in the metadata model 202, as described below. The target package 300 is another package that, for purposes of explanation, contains reports 320 that are targets for reports 220 in the package 200 acting as a drill-through source.

The functions of the source drill-through metadata manager 120 are now further described, referring to FIGS. 2-4. The source drill-through metadata manager 120 allows the modeler to define source drill-through metadata 210, i.e., to mark a query item as a drill-through source item in the source metadata model 202. When a report author 70 designs a report definition 74, the report author 70 does not need to know which query items are marked as drill-through source items. When the consumer 80 runs the report definition 74, the source drill-through metadata manager 120 checks the source drill-through metadata 210 to see if the report definition 74 uses one or more query items that are related to query items marked as drill-through source items, e.g., sibling items of the query items marked as drill-through source items. If the report definition 74 uses one or more of these query items, the source drill-through metadata manager 120 automatically adds data items for the related drill-through source items, i.e., based on the related drill-through source query items, to a source report definition which is used to generate the source report 220.

As shown in FIG. 2, an embodiment of the source drill-through metadata manager 120 has a source drill-through metadata handler 420 and a source specification processor 460.

The source drill-through metadata handler 420 allows the modeler 60 to define and manage source drill-through metadata for query items that are selected as drill-through source items. The source drill-through metadata handler 420 allows the modeler 60 to select a query item, or a container containing multiple query items, and mark it as a drill-through source item. The container may be a query subject or business entity, a level of an OLAP dimension, or a hierarchy of an OLAP dimension. The marking may use a drill-through property of the query item or query subject, e.g., a boolean property or a flag to indicate that it is a drill-through source item.

The source specification processor 460 receives the report definition 74 from the report service 24 and analyzes it to determine if there are any query items used in the report definition 74 related to query items marked as drill-through source items. When such query items are located, the source specification processor 460 adds data items based on the related drill-through source query items to the report definition 74. The data items to be added typically include identifiers of the located source item, e.g., a query item representing a key of a query subject to which the source item belongs. A key is a query item that identifies a query subject instance. A query subject instance contains application data. An instance of a query subject is equivalent to a relational tuple (a row of a table containing column values), and an instance of a dimension, hierarchy or level is equivalent to an OLAP member. For example, an instance of a ‘State’ query subject may contain data values for the columns ‘Code’, ‘CountryCode’, ‘Label’, ‘Area’ and ‘Population’. Also, the data items to be added may be items other than identifiers of the located source item. For example, a data item to be added may be a foreign key query item that identifies an instance of a different query subject, or a query item that defines a value that can be used to find similar instances in the same or other query subject, by searching based on a common label. The added data items are typically not visible in the resultant source report 220, but are available when related items in the source report 220 are selected for drill-through operations.

Thus, the source drill-through metadata manager 120 lets the modeler determine the set of query items that may be added to queries, i.e., reports, to support drill-through operations.

It is desirable to add relevant drill-through items, such as identifiers, to the source report definition. The source drill-through metadata manager 120 can be used to include the relevant drill-through items to the source report definition, and facilitates a productive drill-through experience from various reports, including ad-hoc reports. The source drill-through metadata manager 120 can add additional query items to the report's queries to provide additional context used for the drill-through operations.

In the embodiment shown in FIG. 2, the source drill-through metadata handler 420 and the source specification processor 460 are provided in the source drill-through metadata manager 120 which is shown separately from the report system 20. However, in a different embodiment, the source drill-through metadata handler 420 may be provided as part of the modeling tool 23 of the report system 20. Similarly, the source specification processor 460 may be provided as part of the report service 24 of the report system 20.

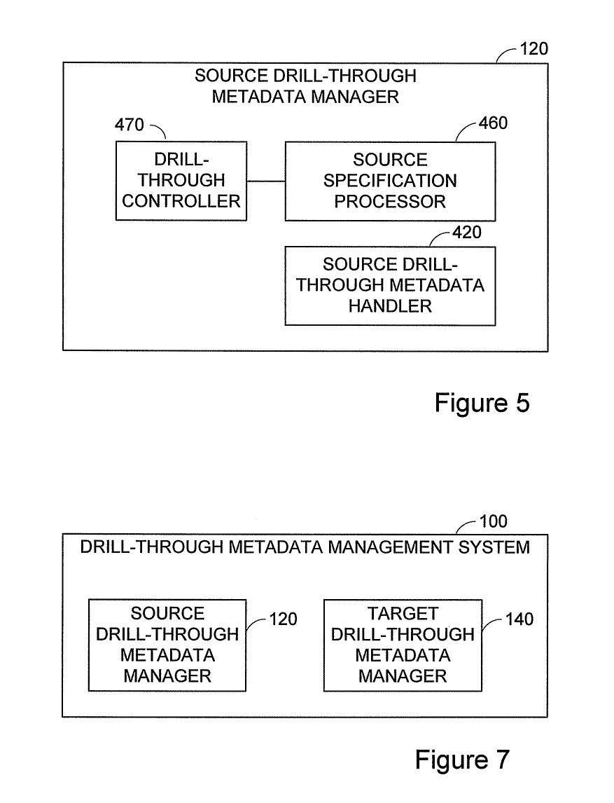

As shown in FIG. 5, the source drill-through metadata manager 120 may also have a drill-through controller 470 to check, when a report definition is run, if the report definition is for a report that can act as a drill-through source. When a report definition is authored, it is typically declared whether the report definition is for a drill-through source report. When the drill-through controller 470 determines that the report definition is for a drill-through source report, the source drill-through metadata manager 120 activates the source specification processor 460. By using the drill-through controller 470, the source specification processor 460 can add those additional query items to a report only when they are necessary to support drill-through. A report that does not act as a drill-through source runs more efficiently and produces smaller outputs since the additional query items are not added to such a report.

For example, a query subject “country” in a relational source has query items: ID, Name and Population. The ID item is a query item conforming to the ISO 3166 Country Code standard (ISO 3166-1-alpha-2) and can therefore identify individual countries, e.g., ‘CA’ is the code for Canada, and ‘US’ is the code for United States. When the modeler selects the query subject “Country” as a drill-through source item, the source drill-through metadata handler 420 marks in the source drill-through metadata 210 of the query subject “Country” as such, e.g., the query subject “Country” is marked. A report author creates a source report definition including a query item of the query subject “Country”, e.g., Name. When the source report definition is run, the source specification processor 460 analyzes the query items in the report definition, and locates the query item Name as a query item of a query subject indicated as a drill-through source query subject. The source specification processor 460 automatically adds the query item ID of the query subject “Country” to the report definition when Name or other query items of the query subject “Country” are referenced.

Another example is when an OLAP source contains the dimension “Geography” with levels “Countries”, “Regions” and “Cities”. The “Countries” level defines the query items “ID”, “Name” and “Population”. The ID query item is identified as a business key (it conforms to the ISO 3166 Country Code standard, as previously described). When the modeler selects the dimension “Geography” as a drill-through source item, the source drill-through property metadata handler 420 marks as such in the drill-through metadata 210, and at runtime if a report definition containing a query item of the level “Countries”, then the source specification processor 460 adds the ID query item of the “Countries” level to the report, as described in the above example. The reporting system 20 may automatically include the member unique name (or MUN) in the dataset retrieved from the OLAP source to perform operations such as drill-up or drill-down. The inclusion of additional identifying query items, such as ID, supports drill-through to targets that may fetch data from a different data source. Typically the MUN of a member can be used during a drill-through operation only when the underlying data source is the same. The source specification processor 460 does not need to add the MUN to the target report if the report system already includes it in the data set.

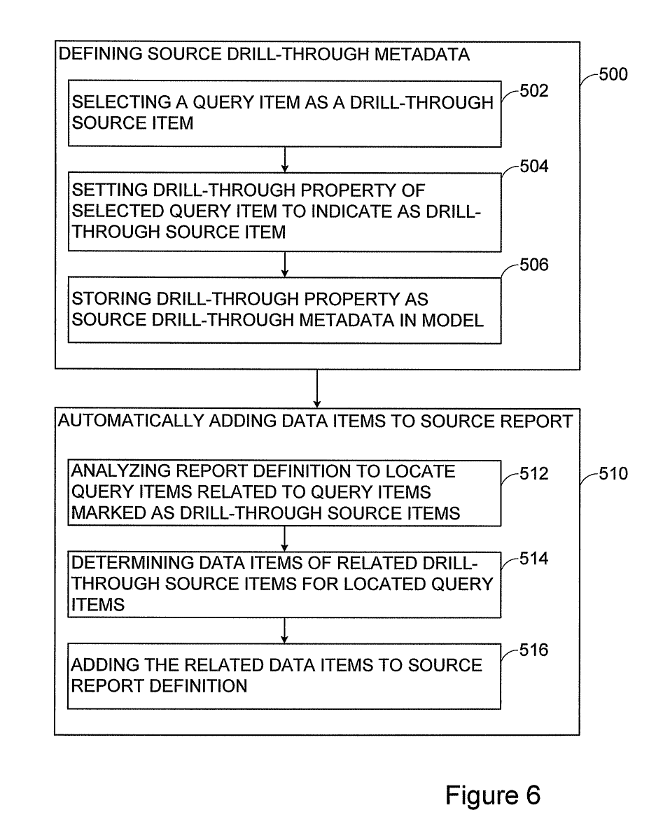

FIG. 6 shows a method of managing drill-through sources in accordance with an embodiment of the invention. The method defines source drill-through metadata (500) by selecting an query item as a drill-through source item (502), and setting a drill-through property of the query item to indicate that it is a drill-through source item (504). The drill-through property is stored as source drill-through metadata in the metadata model (506). Steps 502-506 are repeated for each selected query item.

When a report definition is run, related data items are added to a resultant source report definition (510). This is carried out by analyzing the report definition to locate any query items in the report definition that are related to query items identified as drill-through source items, e.g., sibling items of the query items marked as drill-through source items (512). For the located query item, the related drill-through source item is determined (514). Then, a data item based on the related query item is automatically added to a resultant source report definition (516).

As shown in FIG. 7, the drill-through metadata management system 100 may also have a target drill-through metadata manager 140 in addition to the source drill-through metadata manager 120 described above. The target drill-through metadata manager 140 manages metadata and parameters of drill-through targets and addition of drill-through filters to drill-through targets at runtime.

The target drill-through metadata manager 140 manages target drill-through metadata for query items and the addition of filters to reports at runtime based on the target drill-through metadata to provide the report consumer with additional drill-through opportunities by making it possible to pass more identifying items to the target report. The target drill-through metadata manager 140 works with the report service 24, modeling tool 23 and the metadata service 26 of the report system 20 (FIG. 1).

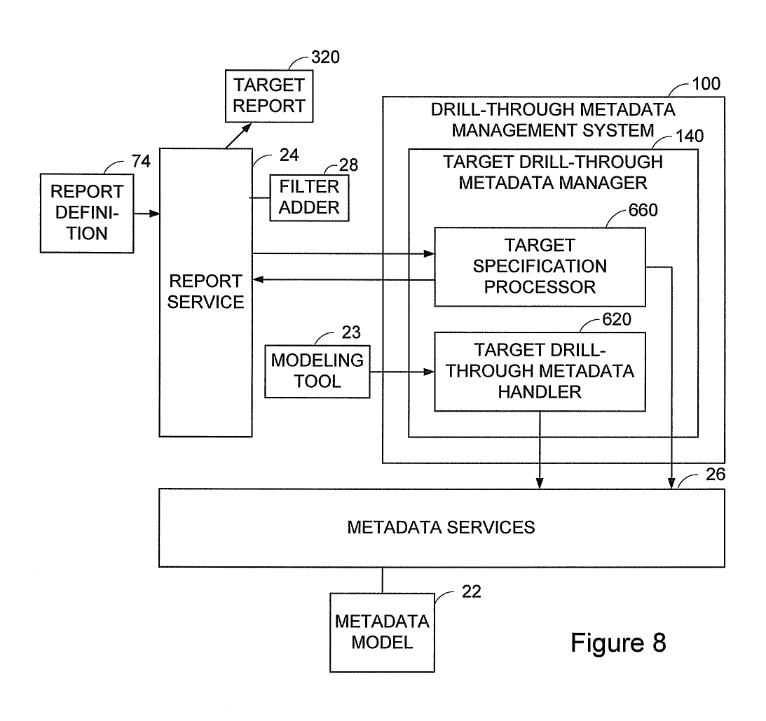

The functions of the target drill-through metadata manager 140 are now further described, referring to FIGS. 3, 4 and 8. The target drill-through metadata manager 140 allows the modeler to define target drill-through metadata 310, i.e., to mark a model construct as a drill-through target construct in the target metadata model 302. A model construct represents any model element that can be marked as a drill-through target construct. When a report author 70 designs a report definition 74, the report author 70 does not need to know which model constructs are marked as a drill-through target construct. The modeler 60 may mark a query subject, query item, dimension, hierarchy or level in the metadata model as a drill-through target construct. When the consumer 80 runs a report definition 74, the target drill-through metadata manager 140 checks the target drill-through metadata 310 to see if the report definition 74 contains one or more data items that use model constructs that are marked as a drill-through target construct or use a part of a model construct marked as a drill-through target construct. If the report definition 74 contains one or more of these data items, the target drill-through metadata manager 140 automatically adds additional data filters to the target report 320.

The additional data filters that are added to the target report 320 are parameterized filters that are used with drill-through operations. These drill-through target filters are associated with a model construct and typically filter instances of the construct using a business key, however, other types of filtering are allowed. A target drill-through filter associated with a query item will typically filter instances of the containing model construct using the query item value.

There are two cases by which a target filter is added to a target report. In the first case, the modeler simply indicates in the target drill-through metadata 310 that the model construct can be used in the target context, and the target drill-through metadata manager 140 constructs the target filter to be added to the target report 320 at runtime. The second case occurs when the modeler needs or wants to provide a custom target filter, and constructs a filter definition in the target drill-through metadata 310. Defining custom target filters in the target drill-through metadata 310 removes the authoring burden from report authors. In any event, the target filter is added to the target report 320 at runtime in the same way using the target drill-through metadata 310, as further described below.

As shown in FIG. 2, an embodiment of the target drill-through metadata manager 140 has a target drill-through metadata handler 620 and a target specification processor 660.

The target drill-through metadata handler 620 allows the modeler 60 to define and manage target drill-through metadata for model constructs that are selected as drill-through target constructs The target drill-through metadata handler 620 allows the modeler 60 to select a model construct, and mark it as a drill-through target construct. The marking may use a drill-through property of the model construct, e.g., a Boolean property or a flag to indicate that it is a drill-through target construct.

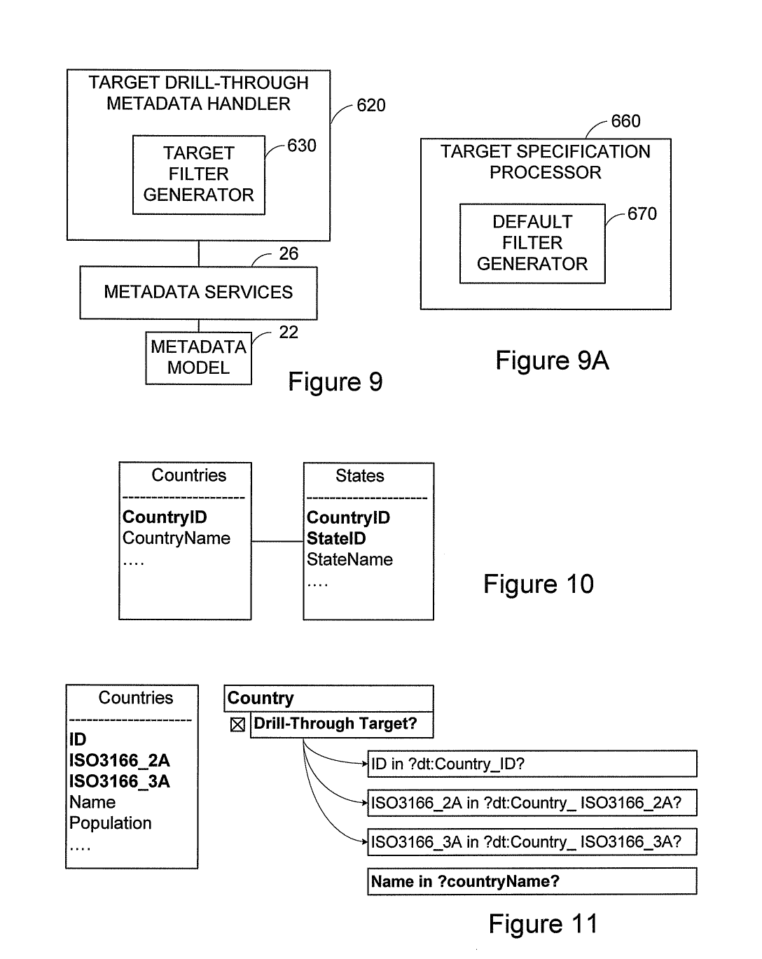

As shown in FIG. 9, the target drill-through metadata handler 620 may have a target filter constructer 630. The target filter constructer 630 allows the modeler to construct one or more custom drill-through target filters for a selected model construct. The target filter constructer 630 stores the constructed custom target filters in the drill-through metadata 310 in association with the selected model construct. In the embodiment shown in FIG. 9, the modeler uses the target filter constructer 630 to construct custom target filters. In a different embodiment, the modeler may use an existing filter defining facility in an existing metadata authoring tool to construct a filter that can be stored in the drill-through metadata 31 as a custom drill-through target filter. The filter stored as a custom drill-through target filter in the drill-through metadata 31 can be applied to a report by the target specification processor 660 when the report is run when a drill-through action triggers the execution of the report.

Thus, the drill-through metadata 310 includes, for each model construct selected as a drill-through target construct, an indication as a drill-through target construct and zero or more custom target filters.

The target specification processor 660 receives the report definition 74 from the report service 24 when the report definition 74 is run, and analyzes the report definition 74, using the metadata to determine if there are any data items used in the report definition 74 that use model constructs (or parts of model constructs) that are marked as drill-through target constructs. When such data items are located, the target source specification processor 660 extracts the target drill-through metadata 310 from the target metadata model 302 to construct the necessary queries. The target specification processor 660 obtains from metadata service 26 additional parameterized target filters that can be used when the target report is used as a drill-through target. For each located model construct, the metadata service 26 checks the target drill-through metadata 310 to see if there is any custom target filter stored for the drill-through target construct. If it finds one or more custom target filters, the metadata service 26 automatically extracts the custom drill-through filters, and provides them to the target specification processor 660. If the metadata service 26 does not find any stored custom target filters for the drill-through target construct, the metadata service 26 automatically generates one or more default target filters, and passes the default target filters to the target specification processor 660.

The target specification processor 660 receives from the metadata service 26 the default target filters generated by the metadata service 26 and/or custom target filters extracted from the target drill-through metadata 310. The metadata service does not distinguish whether a filter is a generated filter of a custom target filter. The target specification processor 660 does not require this information to process the filters. The target specification processor 660 has the received target filters added to a target report 320 by the report service 24 when a drill-through is being performed. The report service 24 has a filter adder 28 to incorporate these target filters into the processing logic of the metadata and report engine components 22, 24 of the report system 20. The filter adder 28 may also include target filters for query items added to the queries to construct the query plans. Once these target filters are included into the processing stream, no other drill-through specific activities are needed to generate a desired target report 320 with these filters added to the drill-through targets. Thus, the resultant target report 320 contains the target filters required to support drill-through. The filter adder 28 may add the target filters to the target report in a similar manner to the incorporation of security filters in a report.

The runtime generation of default target filters is carried out by the metadata service 26. This can eliminate the need to author “normal” filter expressions for drill-through. The modeler can simply select which model constructs are to be used to generate the filters. Report authors are saved the burden of authoring filters to support drill-through. Since the default target filters are generated at run time, they are generated in a manner that is consistent with the metadata.

In order to provide a good match, the metadata service 26 uses business keys in the target filter. For a relational database table with a single key, the metadata service 26 generates a target filter like “itemName in ?Parameter?”. The metadata service 26 names the parameter in a predictable way, e.g., using the query subject name and the query item name in the name, and combines them in a predictable way. For example, the metadata service 26 may use: ‘dt:’ (A prefix to identify drillthrough filters)+QuerySubjectName+‘_’+QueryItemName. For a Country query subject with a Code key query item, the default target filter handler 686 names the parameter ‘dt:Country_Code’, and the filter is “Country.Code in ?dt:Country_Code?”. The metadata service 26 may generate a target filter for each key query item in the subject.

There are some special cases. For example, dates are normally considered ranges, so the metadata service 26 may generate a filter like Orders.OrderDate in_range ?dt:Orders_OrderDate?. For multidimensional models, the subject is replaced by a Dimension, Hierarchy or Level, and the metadata service 26 generates the filter usually based on the Member Unique Name (MUN). Thus, the metadata service 26 generates, e.g., Geography in ?dt:Geography?.

The other example is compound keys that represent a hierarchy. In this case, the metadata service 26 generates a filter: States.CountryCode in ?dt:country_code? And States.StateCode in ?dt:states_statesCode?

In the embodiment described above, the runtime generation of default target filters is carried out by the metadata service 26. In a different embodiment, as shown in FIG. 9A, the target specification processor 660 may have a default target filter generator 670 that carries out the runtime generation of default target filters.

It is desirable that target filters are used when performing drill-through related activities. The target specification processor 660 receives from the report service 24 a run option for drill-through operations, which indicates whether or not a drill-through activity is underway. The target specification processor 660 is activated when the run option indicates that the drill-through activity is underway. By having the target specification processor 660 activated only when the drill-through activity is underway, the performance characteristics of running a report standalone are not affected significantly, and the user experience is better since the user is not presented with an abundance of unnecessary prompts. Allowing the consumer to specify whether the request to the report server is made in the context of a drill-through operation eliminates the need for report authors to trade-off drill-through flexibility for stand-alone behaviour. Ultimately, this functionality eliminates the worst case requirement to author multiple reports that differ only in the degree of parameterization.

When a request that is sent to the report server during a drill-through operation specifies the drill-through run option, the request can leverage the target filters managed in the model by the target drill-through metadata manager 140. In particular, the drill-through run option is used at authoring time to get the metadata for the parameters created by the drill-through target filters. The presumably larger set of parameters can then be used to establish mappings. This metadata can then be used to create parameter assignments which define how source context values are mapped to target parameters to support an effective drill-through experience. Parameter mappings are used to assign data item values from the source domain to parameters in the target domain.

Examples of parameterized target filters are now described. An example is in the case of a relational model having two query subjects, Countries and States, as shown in FIG. 10. The modeler sets the target drill-through metadata 310 to indicate that these query subjects are drill-through targets. When a target report including a query item of either of these query subjects is executed, the target specification processor 660 locates the query item as indicated as a drill-through target, and creates a target filter or finds the custom target filters. For the Countries query subject, the target specification processor 660 creates the following target filter:
[Country].[CountryID] in ?dt:Country_CountryID?

For the States query subject, there are several scenarios. If the StateID query item values are unique, the runtime filter creation handler 686 may create the following filter:
[States].[StateID] in ?dt:States_StateID?

If StateID values are unique only in combination with CountryID, the target specification processor 660 may create the following filter:

[States].[CountryID] in
?dt:Country_CountryID? and [States].[StateID] in
?dt:States_StateID?

This filter defines two prompts that are cascaded automatically. This can be deduced since the filter references items from the same query subject. This filter may allow more rows than expected to appear in the result set. The target drill-through metadata manager 140 allows the modeler to override the default construction.

When multiple target filters define the same parameter (as determined by the name), the metadata service 26 considers those target filters that define the same parameter. The metadata service 26 derives the parameter from the filter that would produce the most restricted dataset. The metadata service 26 determines the target filter to use based on the target context metadata 302, e.g., information of join relationships between items. In the example described above, if both query subjects are used in the report, the metadata service 26 uses the target filter associated with States since States exist within Countries, as determined by the join cardinalities of the relationship between the two subjects. The metadata service 26 also ensures that items in the same position (i.e. [Countries].[CountryID] and [States].[CountryID]) are semantically equivalent. This can usually be deduced from the join expression.

Example of the operation of the target drill-through metadata manager 140 is described. In the example shown in FIG. 11, a query subject “Country” in a relational source has items: ID, ISO3166-2A, ISO3166-3A, Name and Population, in which ID, ISO3166-2A, ISO3166-3A are keys. For this subject, if there is no custom filter stored, the metadata service 26 generates the following three default filters based on the keys and returns them to the specification processor 660:

(default filters)

ID in ?dt:Country_ID?
ISO3166_2A in ?dt:Country_{—} ISO3166_2A?
ISO3166_3A in ?dt:Country_{—} ISO3166_3A?

If the following custom filter is stored, the metadata service 26 extracts the custom filter from the-metadata 310, rather than generating the default filters, and returns the extracted custom filter to the specification processor 660:
(custom filter)
Name in ?countryName?
   This custom filter is constructed by the modeler. Although this is not a key column, it is still a convenient column for filtering purposes.

If the modeler wants to allow filtering using either a key or the custom filter, the modeler defines all four filters manually, thereby so that overriding the default behaviour.

In accordance with another embodiment of the invention, the notion of a target filter can also be extended to support drill-through based on a search paradigm. In this case, non-identifier items are used to filter data. One key aspect of search when compared to drill-through is that filters applied as a result of search should be combined using OR, while standard target filters should be combined using AND.

A consumer may provide the following parameter values when running a report: Colour: Blue; and Line: Camping Equipment. If these values are used with a search, the filter can be expressed as:

Product.Colour=‘Blue’ or Product.Line=‘Camping Equipment’ (1)

If these values are used with a standard drill-through, the filter can be expressed as:

Product.Colour=‘Blue’ and Product.Line=‘Camping Equipment’ (2)

The filter (1) is likely to return more data than the filter (2). This is appropriate given the search paradigm. The filters built for searching are based on metadata defined in the model, but the search filters are constructed in a way that allows more data to be selected. A drill-through operation is “more explicit” about the data that should be selected in the target, i.e., the target data set is typically a subset of the source data set, in terms of the common data items; whereas a search operation typically reverses the relationship between target and source data set, i.e., it searches any drill-through target that matches on any of these values.

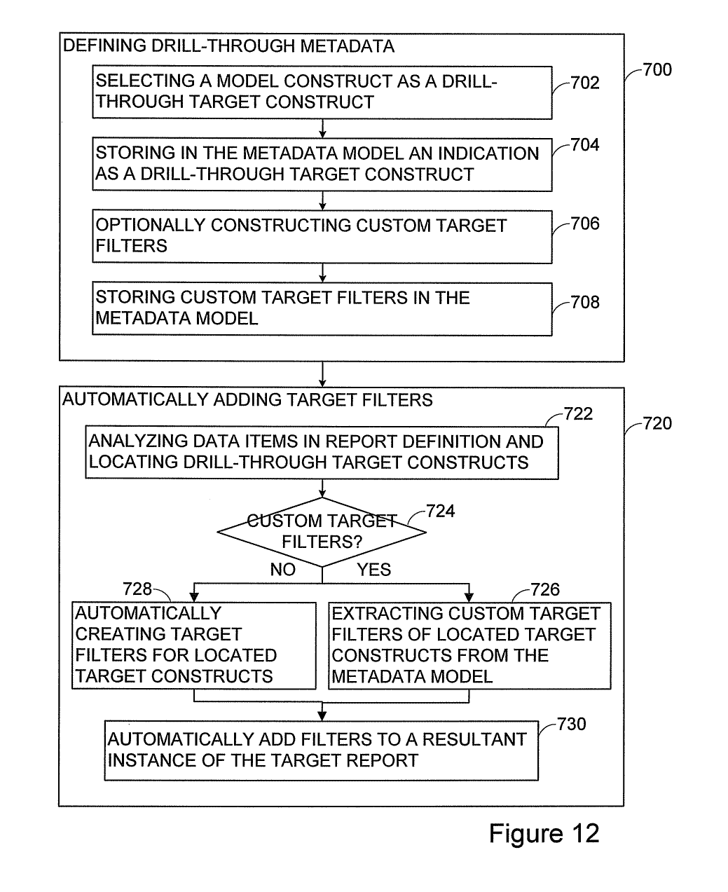

FIG. 12 shows a method of managing drill-through targets in accordance with an embodiment of the invention. The method defines drill-through metadata (700) by selecting a model construct as a drill-through target construct (702), and storing in the metadata model an indication that the selected construct is a drill-through target construct (704). Also, the modeler can optionally construct one or more custom target filters for the selected model construct (706) and stores the custom target filters in the metadata model in association with the selected model construct (708). Steps 702-708 are repeated for each selected model construct.

When a drill-through operation is carried out, one or more target filters are added to a target report (720) by locating one or more references to model constructs in a report definition that are identified as drill-through target constructs using the target metadata model (722), checking in the target metadata model if each located model construct has any custom target filters (724). If there are one or more custom target filters, the custom target filters are used (726). If there is no custom target filter stored for the located item, one or more default target filters are automatically created for the located model construct (728). The custom target filters and/or created target filters are added to the target report (730).

The drill-through metadata management system and the source drill-through metadata manager of the present invention may be implemented by any hardware, software or a combination of hardware and software having the above described functions. The software code, instructions and/or statements, either in its entirety or a part thereof, may be stored in a computer readable memory. Further, a computer data signal representing the software code, instructions and/or statements may be embedded in a carrier wave may be transmitted via a communication network. Such a computer readable memory and a computer data signal and/or its carrier are also within the scope of the present invention, as well as the hardware, software and the combination thereof.

While particular embodiments of the present invention have been shown and described, changes and modifications may be made to such embodiments without departing from the scope of the invention. For example, the elements of the source drill-through metadata manager are described separately, however, two or more elements may be provided as a single element, or one or more elements may be shared with other components in one or more computer systems.

What is claimed is:

1. A source drill-through metadata manager comprising:
a source drill-through metadata handler defining and managing source drill-through metadata in a metadata model for one or more query items that are drill-through source items; and
a source specification processor automatically analyzing data items used in a report definition to locate any data item that uses a query item that is related to a query item defined as a drill-through source item based on the source drill-through metadata so as to identify one or more relevant drill-through source data items for one or more query items located during the analyzing, and automatically adding the one or more relevant drill-through source data items to a source report definition.

2. The source drill-through metadata manager as recited in claim 1, wherein the source specification processor analyzes data items and adds the relevant drill-through source query items when the report definition is run.

3. The source drill-through metadata manager as recited in claim 1, wherein the source drill-through metadata handler allows a modeler to select a query item and indicate that the selected query item is a drill-through source item.

4. The source drill-through metadata manager as recited in claim 3, wherein the source drill-through metadata handler sets a flag to indicate that the query item is a drill-through source item.

5. The source drill-through metadata manager as recited in claim 1, wherein:
the source drill-through metadata handler defines the source drill-through metadata to mark, as a drill-through source item, a query item of a container, the container containing the query item and one or more sibling query items of the query item, an instance of the container containing application data; and
the source specification processor adds the query item of the container to the source report definition when it locates in the report definition a data item that uses a query item that is one of the sibling query items.

6. The source drill-through metadata manager as recited in claim 5, wherein the container is a query subject, an OLAP dimension, a hierarchy of an OLAP dimension, or a level of an OLAP dimension.

7. The source drill-through metadata manager as recited in claim 5, wherein
the query item defined as a drill-through source item is an identifier or key or part of an identifier or key of the container identifying an instance of the container containing one or more query items.

8. The source drill-through metadata manager as recited in claim 5, wherein
the query item defined as a drill-through source item is a foreign key or part of a foreign key of the container identifying an instance of the same or other container containing one or more query items.

9. The source drill-through metadata manager as recited in claim 5, wherein
the query item defined as a drill-through source item is a query item that is used to find similar instances of the same or other container containing one or more query items.

10. The source drill-through metadata manager as recited in claim 1, wherein the source specification processor adds the relevant drill-through source query items so that the added relevant drill-through source data items are invisible on a source report generated from the source report definition but available when the source report is used in a drill-through operation.

11. The source drill-through metadata manager as recited in claim 1 further comprising a drill-through controller determining if the report definition is for a drill-through source report, and activating the source specification processor when the report definition is for a drill-through source report.

12. A method of managing drill-through source metadata, the method comprising the steps of:
defining, in a metadata model, source drill-through metadata for one or more query items that are drill-through source items;
analyzing data items used in a report definition to locate any query item that is related to a query item defined as a drill-through source item based on the source drill-through metadata;
identifying one or more relevant drill-through source query items for one or more query items located during the analyzing, and
automatically adding the one or more relevant data items based on the drill-through source query items to a source report definition.

13. The method as recited in claim 12, wherein the analyzing step, identifying step and automatically step are carried out when the report definition is run.

14. The method as recited in claim 12, wherein the defining step comprises the steps of:
allowing a modeler to select a query item as a drill-through source item;
setting a drill-through property of the selected query item to indicate that the selected query item is a drill-through source item; and
storing the drill-through property as the source drill-through metadata in the metadata model.

15. The method as recited in claim 14, wherein the setting step sets a flag to indicate that the query item is a drill-through source item.

16. The method as recited in claim 12, wherein
the defining step comprises the step of marking, as a drill-through source item, a query item of a container, the container containing the query item and one or more sibling query items of the query items, an instance of the container containing application data; and
the automatically adding step adds the query item of the container to the source report definition when the analyzing step located in the report definition a data item that uses a query item that is one of the sibling query items.

17. The method as recited in claim 16, wherein the marking step marks the query item of the container that is a query subject, an OLAP dimension, a hierarchy of an OLAP dimension, or a level of an OLAP dimension.

18. The method as recited in claim 16, wherein
the query item defined as a drill-through source item by the defining step is a query item that is an identifier or key or part of an identifier or key of the container identifying an instance of the container containing one or more query items.

19. The method as recited in claim 16, wherein
the query item defined as a drill-through source item by the defining step is a query item that is a foreign key or part of a foreign key of the container identifying an instance of the same or other container containing one or more query items.

20. The method as recited in claim 16, wherein
the query item defined as a drill-through source item by the defining step is a query item that is used to find similar instances of the same or other container containing one or more query items.

21. The method as recited in claim 12, wherein the automatically adding step adds the relevant drill-through source query items so that the added relevant data items are invisible on the source report but available when the source report is used in a drill-through operation.

22. The method as recited in claim 12 further comprising the steps of:
determining if a report definition is for a drill-through source report; and
performing the analyzing step, the identifying step and the automatically adding step when the report definition is for a drill-through source report.

23. A drill-through metadata management system comprising:
a source drill-through metadata manager having:
a source drill-through metadata handler defining and managing source drill-through metadata in a metadata model for one or more model items that are drill-through source items; and
a source specification processor automatically analyzing query items used in a report definition to locate any query item that is related to a model item defined as a drill-through source item based on the source drill-through metadata so as to identify one or more relevant drill-through source data items for one or more query items located during the analyzing, and automatically adding the one or more relevant drill-through source data items to a source report definition; and
a target drill-through metadata manager having:
a target drill-through metadata handler defining and managing target drill-through metadata in a metadata model for one or more model constructs that are drill-through target constructs; and
a target specification processor processing a target report definition using the target drill-through metadata to locate a data item that refers to a drill-through target construct or part of a drill-through target construct, and automatically adding one or more target filters associated with the target drill-through construct to a target report.

24. A computer readable medium storing instructions or statements for use in the execution in a computer of a method of managing drill-through source metadata, the method comprising the steps of:
defining, in a metadata model, source drill-through metadata for one or more query items that are drill-through source items;
analyzing query items used in a report definition to locate any query item that is related to a query item defined as a drill-through source item based on the source drill-through metadata;
identifying one or more relevant drill-through source query items for one or more query items located during the analyzing, and
automatically adding the one or more relevant data items to a source report definition.
